(19) United States
(12) Patent Application Publication
(10) Pub. No.: US 2019/0206375 A1
(43) Pub. Date: Jul. 4, 2019

(54) Holding Device for Musical Instruments

(71) Applicants: Franco Esteban Pelaez, Rio Negro (AR); Alejandro Esteban Pelaez, Rio Negro (AR)

(72) Inventors: Franco Esteban Pelaez, Rio Negro (AR); Alejandro Esteban Pelaez, Rio Negro (AR)

(21) Appl. No.: 16/330,236

(22) PCT Filed: Aug. 22, 2017
(86) PCT No.: PCT/CL2017/050043

§ 371 Date: Mar. 4, 2019

(30) Foreign Application Priority Data
Sep. 5, 2016 (AR) P160102702

(51) Int. Cl. G10G 5/00

(52) U.S. Cl. CPC G10G 5/005

(57) ABSTRACT

The invention relates to a device for securing musical instruments, such as guitars, bass guitars and similar, the device comprising a strap or loop having retractable means disposed at the first end thereof, and a means for attaching and securing disposed at the second end thereof, wherein the retractable means allow the strap or loop to be stored and the length thereof to be adjusted during use. The device allows the use height of the instrument to be quickly and safely adjustable and same to be stored and moved in a neat and orderly manner.

### BACKGROUND OF THE INVENTION

### Field of the Invention

This patent refers to a holding device for musical instruments, such as guitars, basses and the like.

### Description of the Related Art

Everybody knows that, to play a musical instrument, like a guitar, in any position that is not sitting down, one must consider the possibility of using a strap. Straps for guitars and other similar instruments hold them while being played, putting their weight on the musician's shoulder so that he can play effortlessly while standing. There are straps in many styles and sizes, some of them are bold, others are simpler; there also are thick cushioned ones and others as thin as a seat belt.

Some of the things to consider when choosing a guitar strap are as follows:

Material: many of the cheapest straps are made of the same material used for seat belts, as was mentioned above. However, very durable leather straps can be found for a very similar price.

Size: this is generally not a serious problem because most guitar straps are adjustable. But even then it is recommended that the strap be long enough so that the guitar can be comfortably played while standing.

Cushioned: some straps are cushioned on the side in contact with the shoulder to play more comfortably. Generally, the cushion is made of polyurethane foam, but other materials are also used.

Style: there is a great variety of colors and designs.

However, all existing straps have a main problem, which is the regulation of their length in order to adapt to the musician's needs. Moreover, if the musician has other straps, the main problem is to store them in an orderly way, because being folded, straps get unfolded and tangled, making it hard to be able to choose one to use.

### BRIEF SUMMARY OF THE INVENTION

Therefore one of the purposes of the present invention is to create a holding device for musical instruments, such as guitars, basses and the like, allowing a tidier and more orderly way of storage and transportation.

Another purpose of the present invention is to create a holding device for musical instruments, such as guitars, basses and the like, whose length can be adapted promptly and safely.

Therefore, one of the purposes of the present invention is to create a holding device for musical instruments, such as guitars, basses and the like, wherein the holding device consists of a strap with retractable means on one end and fastening means on the other end. The retractable means allow the strap's storage and adaptation of its length while being used.

### BRIEF DESCRIPTION OF THE DRAWINGS

To make it more clear and understandable, the purpose of this patent has been illustrated in several figures which show the device in one of the preferred realization ways, as an example, where:

FIG. 1 illustrates the holding device on a musical instrument.

FIG. 2 illustrates various views of the holding device of FIG. 1 in a semi-extended position with direction arrows for extension.

FIG. 3 illustrates various views of the holding device of FIG. 1 in the fully retracted position.

FIG. 4 is an exploded view of the retractor of FIG. 3.

### DETAILED DESCRIPTION

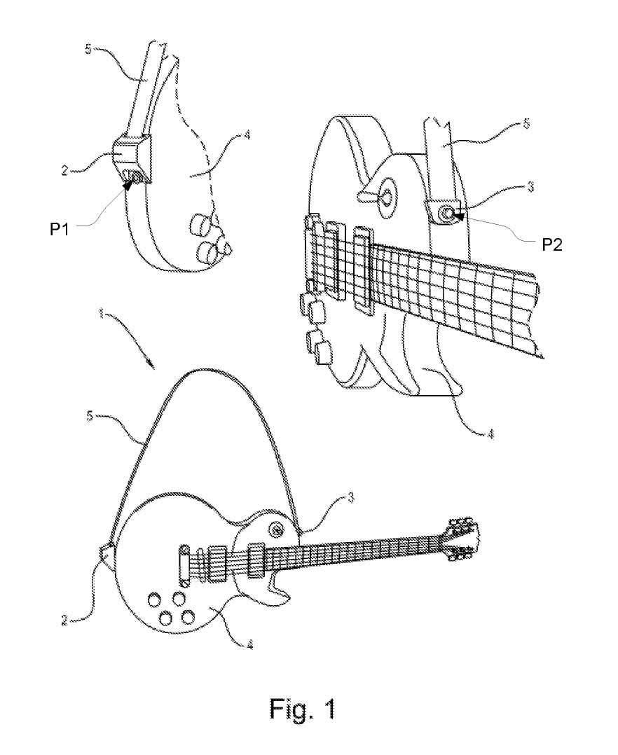

FIG. 1 shows the holding device for musical instruments with reference number 1, set up on a musical instrument with reference number 4. It is important to point out that, although in this realization the holding device 1 is shown set up on an electric guitar 4, the instrument on which the holding device 1 can be set up may be any instrument such as an electric bass, banjo, electro acoustic guitar and any other instrument that requires a device such as this one.

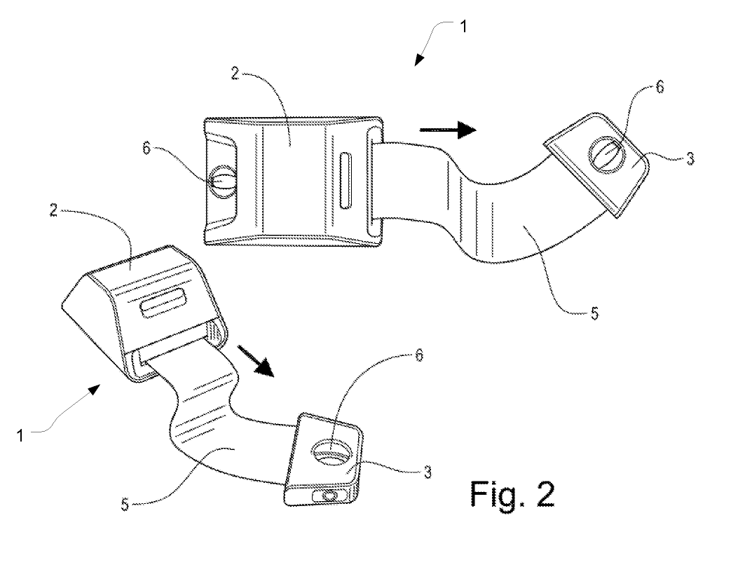

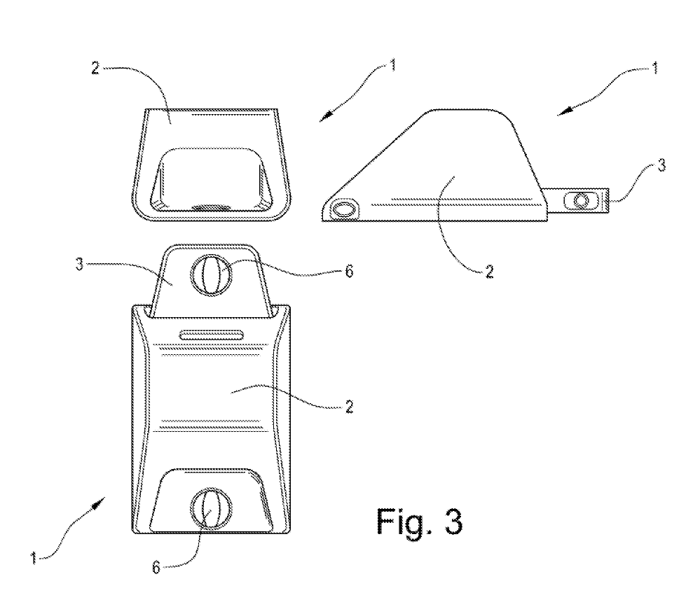

FIGS. 2 and 3 show various views of the holding device 1, which consists of a strap 5 coupled to a retractable means or retractor 2 on its first end, and a fastener or fastening means 3 on its second end. The retractor 2 allows for the storage and regulation of the strap's length while it is being used. The fastener 3 consists of a buckle with a fastening orifice 6.

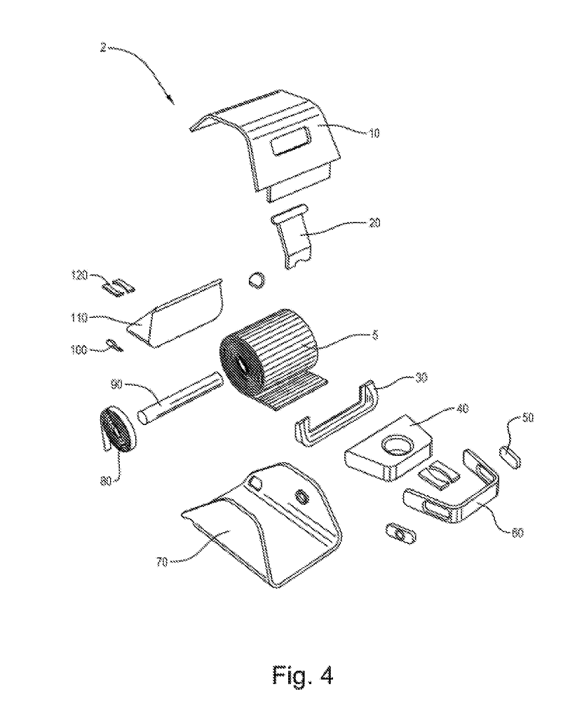

FIG. 4 shows an exploded view of the retractor 2 with strap 5 fully retracted, which in this realization consists of an upper lid 10, a strap lock 20, a strap 5, a front case 30, a supporting back case 40, a supporting lock button 50, a supporting front case 60, a lower case 70, a spiral spring 80, an axle 90, a main lock button 100, a back case 110 and a clip 120.

It is evident for any expert in the subject that the above mentioned components can vary in their configuration so as to adapt to the particular features (size, weight, set up points, etc.) of the musical instruments where the holding device 1 of this patent is used.

Just as an example, a description regarding the use of the holding device 1 will be provided. After choosing a musical instrument that he is going to play, the user couples the holding device 1 to the musical instrument as follows. The retractor 2 is coupled to the musical instrument by inserting a first fixing pin, e.g. P1, which generally comes in every guitar, through the orifice 6 of the retractor. Once the retractor 2 is coupled in position, the user pulls on the fastener 3 as shown in the arrow in FIG. 2. The user pulls on the fastener until strap 5 stretches around the user's back and above the shoulder until orifice 6 of fastener 3 reaches the second fixing pin, e.g. P2, of the guitar. A locking mechanism in the retractor 2, fixes the strap in position while the instrument is used.

When the user no longer wishes to use the holding device 1, the user removes it from the guitar's pins, i.e. P1 and P2; then pushes the supporting lock button 50, allowing the pressure on the spring 80 to retract and roll up strap 5 on axle 90 until the fastener 3 abuts the supporting front case 60. In this configuration, holding device 1 remains retracted and ready to be stored, without getting tangled with other devices or materials during transportation.

1. (canceled)

2. (canceled)

3. (canceled)

4. A holding device for musical instruments comprising:
a strap with a first and second end;
a fastener fixedly coupled to the first end of the strap, wherein the fastener comprises a first orifice for removably coupling to a first fixing pin of a musical instrument; and
a retractor fixedly coupled to the second end of the strap, wherein the retractor comprises a second orifice for removably coupling the retractor to a second fixing pin of the musical instrument, wherein said retractor is configured to facilitate storage of the strap and adaptation of the strap's length for use.

5. The holding device of claim 4, wherein the retractor comprises an axle coupled to a spiral spring, wherein the second end of the strap is coupled to the axle such that extension of the strap loads up the spiral spring, wherein the retractor further comprises a main lock button for locking the strap in an extended position.

6. The holding device of claim 4, wherein the fastener comprises a buckle.
